(19) United States
(12) Patent Application Publication
(10) Pub. No.: US 2006/0038495 A1
(43) Pub. Date: Feb. 23, 2006

(54) Protective layer for plasma display panel and method for forming the same

(76) Inventors: Min-Suk Lee, Suwon-si (KR); Jong-Seo Choi, Suwon-si (KR); Suk-Ki Kim, Suwon-si (KR); Jae-Hyuk Kim, Suwon-si (KR); Soon-Sung Suh, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/208,084

(22) Filed: Aug. 19, 2005

(30) Foreign Application Priority Data
Aug. 20, 2004 (KR) 10-2004-0065879

(51) Int. Cl. H01J 17/49

(52) U.S. Cl. 313/587

(57) ABSTRACT

Herein is provided a protective layer for a plasma display panel and a method of forming the protective layer. The protective layer is formed on a substrate of the plasma display panel which includes sustain electrodes. Grain columns having directionality are formed in the texture of the protective layer. Because the direction of the grain columns can be controlled, the general orientation of the voids is known, and an electric field can be applied for discharge in a direction where the number of voids is smallest. As a result, the etching rate of the protective layer can be reduced, thereby increasing the lifetime of the protective layer. In addition, since discharge ions are less likely to impact the protective layer rapid emission of secondary electrons and reduced discharge delay time is realized. It is therefore possible to shorten the discharge delay time and to improve the breakdown voltage of discharge.

### CROSS-REFERENCE TO RELATED PATENT APPLICATION

This application claims the benefit of Korean Patent Application No. 10-2004-0065879, filed on Aug. 20, 2004, in the Korean Intellectual Property Office, the disclosure of which is incorporated herein in its entirety by reference.

### BACKGROUND OF THE INVENTION

1. Field of the Invention

The present invention relates to a protective layer for a plasma display panel (PDP) and a method of forming the protective layer, and more particularly to a protective layer for a plasma display panel in which grain columns having predetermined directionality are formed in the texture thereof and a method of forming the protective layer.

2. Description of the Related Technology

Plasma display panels (PDPs) have features such as large screens, excellent display quality due to its spontaneous emission, and fast response speed. Since PDPs can be reduced in thickness, PDPs are excellent for wall-hanging displays, similar to LCDs and the like.

FIG. 1 shows one pixel of several hundred thousands pixels in a PDP. The structure of a plasma display panel is now explained with reference to FIG. 1. A discharge sustain electrode 15, which has an X electrode and a Y electrode, is formed on a front substrate 14 and the discharge sustain electrode 15 is covered with a front dielectric layer 16. When the dielectric layer 16 is exposed directly to a discharge space, discharge quality is deteriorated and the device lifetime is shortened. Therefore, a protective layer 17 is formed using a thin film process so as to protect the dielectric layer 16. The protective layer 17 serves to discharge secondary electrons 18, as well as to protect the rear surface of the front dielectric layer 16 from impacts of gas ions at the time of plasma discharge. Therefore, it is desirable that the protective layer satisfies conditions such as insulating property, etching-resistance, low discharge voltage, fast discharge response characteristic, and high visible-light transmittance.

On the other hand, transparent electrodes 15 made of patterned ITO or the like is formed on the front substrate 14, bus electrodes are formed on the transparent electrodes 15, and the front dielectric layer 16 is printed using a printing method. Address electrodes 11 are disposed on the top surface of a rear substrate 10, and a rear dielectric layer 12 is formed on the top surface of the rear substrate 10 so as to cover the address electrodes 11. On the other hand, the front substrate 14 and the rear substrate 10 are separated from each other by barrier ribs with a gap of several tens of μm therebetween. A fluorescent layer 13 is formed in emission cells partitioned by the barrier ribs 19. The gap between the front substrate 14 and the rear substrate 10 is filled with a mixture gas of Ne+Xe or a mixture gas of He+Ne+Xe with a constant pressure (for example, 450 Torr) for generating ultraviolet rays.

The Xe gas serves to generate vacuum ultraviolet rays (147 nm resonant radiation of Xe ion and 173 nm resonant reflected light of Xe2), and the Ne gas or the mixture of Ne+Xe gas serves to lower the breakdown voltage.

On the other hand, it is disclosed in Korean Unexamined Patent Application Laid-open No. 2001-48563 that the secondary electron emission coefficient of Xe as a discharging gas is increased by doping a protective layer with a minute amount of impurities. However, when the Xe gas is used without consideration of the structural arrangement of the texture of the protective layer, although vacuum ultraviolet rays with high density can be radiated to increase the visible-light conversion efficiency up to the quantum efficiency of fluorescent materials, the breakdown voltage is too high to apply to display devices. Therefore, in order to lower the breakdown voltage, which is increased with an increase in concentration of Xe gas, He gas is added to the mixture gas of Ne+Xe. This is advantageous for lowering the breakdown voltage because of the increase in the mobility of Xe due to the addition He ions. However, the addition of He causes damage to the protective layer and the fluorescent material due to sputtering etching.

### SUMMARY OF CERTAIN INVENTIVE EMBODIMENTS

One inventive aspect is a protective layer for a plasma display panel in which grain columns having predetermined directionality are formed in the texture of the protective layer so as to allow for a lower etching rate, to greatly reduce the etching of MgO, to lower the breakdown voltage, and therefore to improve discharge quality. A method of forming the protective layer is also presented.

In one embodiment, there is a protective layer for a plasma display panel, the protective layer being formed on a substrate of the plasma display panel which has sustain electrodes, wherein grain columns having predetermined directionality are formed in the texture of the protective layer.

Here, the grain column density of a first direction may be different from the grain column density of a second direction. In this case, the first direction may be perpendicular to the second direction.

The first direction may be perpendicular to the longitudinal direction of the sustain electrodes of the plasma display panel.

The protective layer may be formed using an electron-beam deposition method to which laser pulses or plasma ions are introduced.

Alternatively, the protective layer may be formed using a sputtering deposition method to which laser pulses or plasma ions are introduced.

Alternatively, the directionality may be given to the grain columns by tilting the substrate with respect to the deposition direction during deposition of the protective layer.

The protective layer may include MgO.

In another embodiment, there is provided a method of forming a protective layer for a plasma display panel on a substrate of the plasma display panel including sustain electrodes, wherein grain columns having predetermined directionality are formed in the texture of the protective layer.

In the method of forming the protective layer, the column density of a first direction in the grain columns may be different from the column density of a second direction. In this case, the first direction may be perpendicular to the second direction.

In the method of forming the protective layer, the first direction may be perpendicular to the longitudinal direction of the sustain electrodes of the plasma display panel.

Specifically, the protective layer may be formed using an electron-beam deposition method or a sputtering deposition method to which laser pulses or plasma ions are introduced. In addition, the protective layer may be formed by tilting the substrate to give directionality to the grain columns.

Another embodiment provides a plasma display panel comprising a protective layer formed between a dielectric comprising sustain electrodes, and a discharge space, wherein the protective layer comprises grain columns having predetermined directionality.

In such a plasma display panel the protective layer may further comprise a grain column density in a first direction differing from the grain column density in a second direction. The first direction may also perpendicular to the longitudinal direction of the sustain electrodes.

In another embodiment, a plasma display panel may be formed by a process comprising depositing the protective layer using an electron-beam or a sputtering deposition method comprising application of laser pulses or plasma ions. Additionally a plasma display panel may be formed by a process comprising tilting the substrate with respect to the deposition direction during deposition of the protective layer.

### BRIEF DESCRIPTION OF THE DRAWINGS

The above and other features and advantages of certain inventive aspects are discussed with further detailed exemplary embodiments with reference to the attached drawings in which:

FIG. 1 is a cross-sectional view illustrating an internal structure of a conventional reflective plasma display panel (PRIOR ART);

FIG. 2 is an explanatory diagram illustrating Auger neutralization for explaining emission of electrons from a solid due to gas ions;

FIG. 3 is an exploded perspective view of a plasma display panel according to the present invention;

FIG. 4 is an exploded perspective view illustrating a state where a front panel is lifted up;

FIG. 5 is an enlarged view schematically illustrating a cross-section of a protective layer in which grain columns are formed; and

FIG. 6 is an enlarged view schematically illustrating directionality of a protective layer in which grain columns are formed.

### DETAILED DESCRIPTION OF CERTAIN INVENTIVE EMBODIMENTS

Certain inventive embodiments will now be described more fully with reference to the accompanying drawings, in which exemplary embodiments are shown.

The protective layer of a plasma display panel has three functions.

First, the protective layer has a function of protecting electrodes and dielectric. Electric discharge can be generated by only the electrodes or the electrodes and dielectric. However, it is difficult to control discharge current with only the electrodes. Additionally, only the electrodes and dielectric have a problem with sputtering etching. Therefore, the dielectric must be coated with a protective layer having a resistance to plasma ions to protect the electrodes and the dielectric.

Second, the protective layer has a function of lowering the breakdown voltage of the discharge. A physical quantity associated directly with the breakdown voltage is the secondary-electron emission coefficient of the protective layer with respect to the plasma ions. Since the secondary-electron emission coefficient is inversely proportional to the breakdown voltage, the breakdown voltage is lowered with increase in secondary-electron emission of the protective layer. Since the dielectric layer has a very low secondary-electron emission coefficient, the protective layer can have a high secondary-electron emission coefficient to compensate.

Third, the protective layer also has a function of shortening the discharge delay time. The discharge delay time is a physical quantity indicating a phenomenon that electric discharge occurs some time after application of a voltage. The discharge delay time is expressed as a sum of delay time of formation (Tf) and delay time of statistics. The delay time of formation indicates difference in time between applied voltage and discharge current and the delay time of statistics indicates statistical dispersion of the delay time of formation. A decrease in the discharge delay time makes possible high-speed addressing and single scan, thereby reducing the cost for scan drive. In addition, the number of sub fields can be increased, thereby enhancing brightness and display quality.

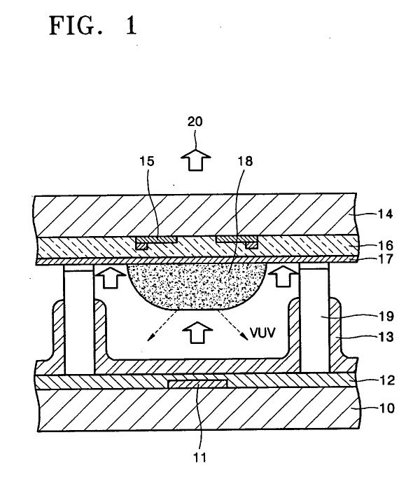

Referring to FIG. 1 (Prior Art) which shows a cross-sectional view of a conventional plasma display panel, when a voltage is applied across the sustain electrode 15 and the address electrode 11, seed electrons generated from cosmic rays or ultraviolet rays collide with gas particles to generate gas ions, and the gas ions collide with the protective layer 17 to allow the protective layer 17 to emit many secondary electrons. Thus, a sufficient quantity of electrons is generated in the discharge cell to cause a discharge.

On the other hand, the emission of secondary electrons from the protective layer can be explained on the basis of Auger Neutralization. That is, when gas ions collide with a solid, electrons are transferred from the solid to the gas ions, thereby neutralizing the gas. When this happens, the electrons are emitted to the vacuum from the solid, thereby forming holes in the solid. The secondary-electron emission coefficient can be expressed by the following equation.
Ek=EI−2(Eg+χ) (1)

Here, Ek indicates energy when the electrons are emitted from the solid to the vacuum, EI indicates ionization energy of gas, Eg indicates band-gap energy of the solid, and χ indicates electron affinity.

Table 1 shows resonance emission wavelengths and ionization voltages of inert gases.

TABLE 1
Inert gases and Ionization energy

| | | | | Excitation at | | |
|---|---|---|---|---|---|---|
| | Excitation at resonance level | | | metastable level | | |
| | | Wavelength | Lifetime | | Lifetime | Ionization |
| gas | Voltage (V) | (mm) | (ns) | Voltage (V) | (ns) | voltage (V) |
| He | 21.2 | 58.4 | 0.555 | 19.8 | 7.9 | 24.59 |
| Ne | 16.54 | 74.4 | 20.7 | 16.62 | 20 | 21.57 |
| Ar | 11.61 | 107 | 10.2 | 11.53 | 60 | 15.76 |
| Kr | 9.98 | 124 | 4.38 | 9.82 | 85 | 14.0 |
| Xe | 8.45 | 147 | 3.79 | 8.23 | 150 | 12.13 |

Xe gas emitting vacuum ultraviolet rays having long wavelengths can be suitably used for enhancing light conversion efficiency of fluorescent materials. However, the Xe ion has a small ionization voltage. Accordingly, when the band-gap energy of the solid Eg is 7.7 eV and the electron affinity χ is 0.5 in Equation 1, Ek<0. Therefore, the Xe gas has a very high discharge voltage. As a result, a gas having a high ionization voltage may be used for lowering the discharge voltage,

According to Equation 1, Ek of He (8.19 eV) is greater than Ek of Ne (5.17 eV). Accordingly, discharge can occur at a lower voltage with He. However, when He gas is used for the PDP discharge, the mobility of Xe increases and thus causes more severe etching of the protective layer, thereby damaging the protective layer. Therefore, Ne+Xe gas may be used for the PDP. The concentration of Xe may be greater than 5%. The concentration of Xe can be increased to enhance the brightness, but the discharge voltage is also increased.

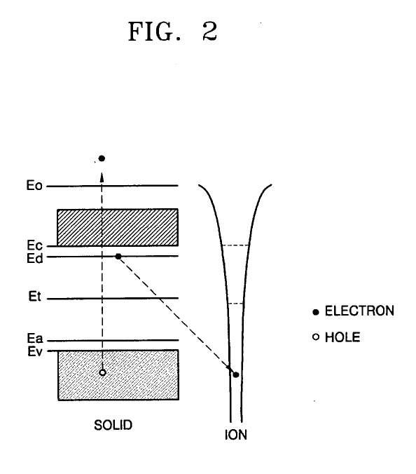

On the other hand, FIG. 2 shows the emission of electrons from a solid due to the gas ions while varying the band gap of MgO. MgO used for the protective layer of a plasma display panel is a wide band-gap material like diamond and the electron affinity thereof is very small or is negative. The protective layer can have a band-gap minimizing effect by simultaneously forming a donor level Ed, an acceptor level Ea, and a deep level Et between the valence band Ev and the conduction band Ec because of the doping of impurities. Since the effective band-gap energy Eg can be less than 7.7 eV in Equation 1, the value of Ek of Xe is greater than 0. MgO can be obtained from one or more of magnesium oxide and magnesium salt. Here, the magnesium oxide may include MgO and the magnesium salt may include MgCO₃ or Mg(OH)₂.

The structural arrangement of the protective layer can lower the breakdown voltage of discharge and reduce the plasma etching. Modifying the texture of the protective layer, as well as the selection of the protective layer material can contribute to better performance.

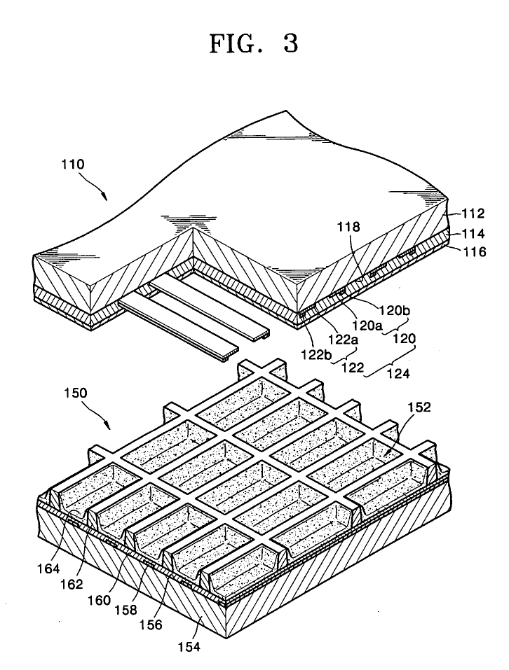

FIG. 3 is an exploded perspective view of a plasma display panel having the protective layer. Referring to FIG. 3, the plasma display panel having the protective layer includes a front panel 110 and a rear panel 150 facing each other. The front panel 110 and the rear panel 150 are spaced with a predetermined gap and emission cells 152 are formed therebetween.

Address electrodes 158 are formed on the rear substrate 154 of the rear panel 150 and the address electrodes 158 are covered with a rear dielectric layer formed on the front surface 156 of the rear substrate 154.

The front panel 110 includes a front substrate 112 which is a transparent substrate transmitting visible light and which may be made of glass. A plurality of pairs of sustain electrodes 124 disposed in stripes so as to be perpendicular to the address electrodes 158 formed on the rear substrate 154 are formed on the rear surface 118 of the front substrate 112. Each pair of sustain electrodes has an X electrode 120a,b and a Y electrode 122a,b. In one embodiment, the X electrode 120a,b includes a transparent electrode 120a made of a transparent material such as ITO and a bus electrode 120b made of metal having excellent conductivity, and the Y electrode 122 includes a transparent electrode 122a made of ITO and a bus electrode 122b having excellent conductivity.

A front dielectric layer 114 covering the pairs of sustain electrodes 124 is formed on the rear surface 118 of the front substrate 112 on which the pairs of sustain electrodes 124 are formed. A protective layer 116 is then formed on the front dielectric layer 114. Barrier ribs partitioning the respective emission cells 152 are formed between the front panel 110 and the rear panel 150, and a fluorescent layer 164 is coated in the partitioned emission cells 152.

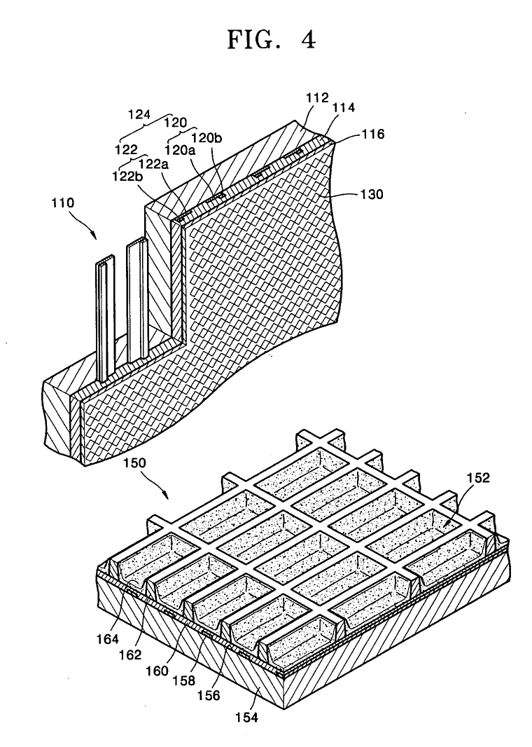

FIG. 4 is an exploded perspective view illustrating a state where a front panel of the plasma display panel of FIG. 3 is lifted up and rotated by 90°.

Referring to FIG. 4, in some embodiments a texture is formed in the protective layer by a particular arrangement of the grain columns 130. The grain columns 130 of the protective layer are arranged in a predetermined direction so as to protect the pairs of sustain electrodes 124 and the front dielectric layer 114.

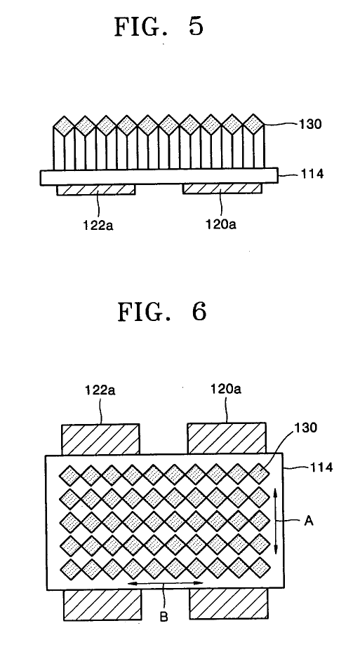

FIG. 5 is a cross-sectional view illustrating the protective layer in which the grain columns 130 are formed. For the purpose of convenient explanation, FIG. 5 shows only some elements of the internal structure of the plasma display panel.

The transparent electrodes 120a and 122a of a pair of sustain electrodes are covered with the front dielectric layer 114 and the protective layer is formed on the front dielectric layer 114. As a result, the grain columns 130 of the protective layer are on the front dielectric layer 114.

FIG. 6 is a plan view corresponding to FIG. 5 and shows an arrangement of the grain columns 130.

Referring to FIG. 6, column density of the grain columns 130 is direction dependent. In one direction, shown as B in FIG. 6, the grain columns 130 are formed closer to one another, or more densely than in the perpendicular direction, shown as A in FIG. 6. Referring to FIGS. 4 and 6, the direction B in which the texture is denser is perpendicular to the longitudinal direction of the pair of sustain electrodes 124, that is, the longitudinal direction of the transparent electrodes 120a and 122a. Therefore, when the protective layer 116 is formed on the front panel, the grain columns 130 in the protective layer texture are formed to be denser in the direction perpendicular to the pair of sustain electrodes and to be less dense in the direction parallel to the pair of sustain electrodes.

When the arrangement of the grain columns does not have predetermined directionality, voids are distributed randomly, and when the arrangement of the grain columns has predetermined directionality, voids are formed to be parallel to the first direction in which the grain columns are dense. Therefore, the voids are smaller in the first direction in which the grain columns are dense and the voids are larger in the second direction in which the grain columns are less dense. Thus, the grain column density is anisotropic.

When the direction B in which the column density of the grain columns 130 in the protective layer texture is higher is formed to be perpendicular to the longitudinal direction (indicated by the arrow A in FIG. 6) of the pair of sustain electrodes, the following two improvements can be obtained.

First, the etching rate of the protective layer is reduced. Since the plasma ions move in the denser direction at the time of application of a voltage to the pair of sustain electrodes, it is less likely that the ions will impact the protective layer 116. Damage to the MgO component of the protective layer is greatly reduced.

Second, the discharge quality can be improved. Since the arrangement of the grain columns of the conventional protective layer is random and does not have predetermined directionality, the voids are distributed randomly and the surface roughness is not constant. Therefore, it is not easy to reduce the discharge delay time. However, when the arrangement of the grain columns has predetermined directionality, since an electric field is applied in the first direction B which is the denser direction, the plasma ions are less hindered by the voids or surface roughness when the plasma ions move along or over the surface of the protective layer. Therefore, the secondary electrons can be emitted more rapidly. This results in a shorter discharge delay time and lower breakdown voltage.

When the protective layer is formed on the dielectric layer using the conventional deposition method such as an electron-beam deposition method and a sputtering deposition method, the protective layer texture tends to have a random arrangement of grain columns which have a particular crystal orientation. Other conventional deposition methods such as a screen printing method, a sol-gel coating method, a spin coating method, and a dipping method also do not tend to produce the predetermined arrangement.

The axis direction of the grain columns on the front dielectric layer of PDP may influence the crystal directions of protective layer materials. The primary crystal plane depends upon deposition conditions (such as substrate temperature, ambient gas, pressure, etc.) The diameter and shape of the grain columns can vary depending upon the deposition conditions, but the arrangement tends to be random. The arrangement of grain columns having predetermined directionality can be accomplished by introducing two other methods to the conventional deposition methods. One method is that laser pulses or plasma ions are introduced to the electron-beam deposition method or the sputtering deposition method, and the other method is that a substrate is tilted by a predetermined angle with respect to the deposition direction.

When a layer is formed using the electron-beam deposition method or the sputtering deposition method including laser pulses or plasma ions, the laser beams or plasma ions arrange the grain columns in the direction of the beams or ions. On the other hand, the method of tilting the substrate to give the predetermined arrangement can also be applied. This method may be particularly advantageous in a case where the substrate has a small size.

According to some embodiments described above, it is advantageous for allowing higher concentration of Xe and the use of single scan.

Since the direction of the voids can be determined by giving predetermined directionality to the arrangement of grain columns in the texture of the protective layer, an electric field can be applied in the direction where the voids are smaller. Accordingly, the etching rate of the protective layer by the plasma ions can be reduced and the lifetime of the protective layer can be increased. In addition, since the discharge ions are less likely to impact the protective layer rapid emission of secondary electrons is realized. It is therefore possible to shorten the discharge delay time and to improve the breakdown voltage of discharge.

Compared with the conventional protective layer, it is possible to further improve characteristics such as protective layer etching rate, breakdown voltage, delay and time of discharge. By giving the predetermined directionality to the grain columns in the protective layer texture, the protective layer etching rate can be reduced, thereby lengthening the lifetime of the panel. The breakdown voltage can be further lowered, thereby suppressing an increase in discharge voltage with increase in content of Xe for the purpose of enhancing brightness. The discharge delay time can be shortened to speed up the addressing, thereby realizing single scan for an HD-class panel. The number of sustain discharges can also be increased, thereby increasing the brightness. In addition, the number of sub-fields constituting a TV-field can be increased, thereby reducing pseudo-outlines.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A protective layer for a plasma display panel, the protective layer being formed on a substrate of the plasma display panel comprising sustain electrodes, wherein grain columns are formed in the texture of the protective layer.

2. The protective layer of claim 1, wherein the grain column density of a first direction is different from the grain column density of a second direction.

3. The protective layer of claim 2, wherein the first direction is perpendicular to the second direction.

4. The protective layer of claim 2, wherein the first direction is perpendicular to the longitudinal direction of the sustain electrodes of the plasma display panel.

5. The protective layer of claim 1, wherein the protective layer is formed using an electron-beam deposition method comprising application of laser pulses or plasma ions.

6. The protective layer of claim 1, wherein the protective layer is formed using a sputtering deposition method comprising application of laser pulses or plasma ions.

7. The protective layer of claim 1, wherein the predetermined directionality is given to the grain columns by tilting the substrate with respect to the deposition direction during deposition of the protective layer.

8. The protective layer of claim 7, wherein the protective layer comprises MgO.

9. A method of forming a protective layer for a plasma display panel on a substrate of the plasma display panel including sustain electrodes, the method comprising:
forming grain columns with predetermined directionality in the texture of the protective layer.

10. The method of claim 9, further comprising forming the grain columns such that the grain column density of a first direction is different from the grain column density of a second direction.

11. The method of claim 10, wherein the first direction is perpendicular to the second direction.

12. The method of claim 10, wherein the first direction is perpendicular to the longitudinal direction of the sustain electrodes of the plasma display panel.

13. The method of claim 9, further comprising using an electron-beam deposition method comprising application of laser pulses or plasma ions.

14. The method of claim 9, further comprising using a sputtering deposition method comprising application of laser pulses or plasma ions.

15. The method of claim 9, further comprising tilting the substrate with respect to the deposition direction during deposition of the protective layer to give the grain columns the predetermined directionality.

16. A plasma display panel comprising a protective layer formed between a dielectric comprising sustain electrodes, and a discharge space, wherein the protective layer comprises grain columns having predetermined directionality.

17. The plasma display panel of claim 16, wherein the protective layer further comprises a grain column density in a first direction differing from the grain column density in a second direction.

18. The plasma display panel of claim 17, wherein the first direction is perpendicular to the longitudinal direction of the sustain electrodes.

19. The plasma display panel of claim 16 formed by a process comprising depositing the protective layer using an electron-beam or a sputtering deposition method comprising application of laser pulses or plasma ions.

20. The plasma display panel of claim 16 formed by a process comprising tilting the substrate with respect to the deposition direction during deposition of the protective layer.

21. The plasma display panel of claim 16, wherein the protective layer has an anisotropic grain column density.
